(19) United States
(12) Patent Application Publication
(10) Pub. No.: US 2017/0222586 A1
(43) Pub. Date: Aug. 3, 2017

(54) Mobile waterborne energy platform that produces electrical power

(71) Applicant: Nautilus Data Technologies, Inc., San Ramon, CA (US)

(72) Inventors: Arnold C. Magcale, San Ramon, CA (US); Daniel Kekai, San Ramon, CA (US)

(21) Appl. No.: 14/591,638

(22) Filed: Jan. 7, 2015

Related U.S. Application Data
(60) Provisional application No. 61/925,533, filed on Jan. 9, 2014.

(51) Int. Cl. H02P 9/08; H01M 8/04; F02C 7/16; G05B 15/02

(52) U.S. Cl. CPC H02P 9/08; G05B 15/02; H01M 8/04029; H01M 8/04044; F02C 7/16

(57) ABSTRACT

A mobile waterborne energy platform systems and methods comprising a purpose built marine vessel, a pre fabricated building structure, a plurality of fuel cells or generators, a plurality of fuel tanks, a plurality of mechanical equipment, a plurality of electrical equipment and a method to transmit electrical power to shore or to another marine vessel. The mobile waterborne energy platform systems and methods described may be employed to quickly provide utility grade electrical power to remote austere locations. The electrical power may be produced by a plurality of fuel cells or generators configured on a mobile waterborne vessel that may be transported to remote areas to provide an on site electrical power source for critical infrastructure, communications, emergency or medical facilities. The systems and methods are ideal for military purposes where troops may be deployed in remote locations without readily available utility grade electrical power.

### CROSS REFERENCE TO RELATED APPLICATIONS

This application claims reference to Provisional Patent application No. 61/925,533 filed on Jan. 9, 2014, entitled “A mobile waterborne energy platform that produces electrical power.”

### FIELD

The present invention relates to mobile waterborne energy platforms that produce electrical power.

### BACKGROUND

Problem Solved: When a natural disaster strikes the impact on communities and businesses can be devastating. Restoring electrical power to areas following a natural disaster is crucial to the recovery process. In many cases electrical power sources may be unavailable for weeks prior to being fully restored.

Military deployments in remote austere locations face challenges providing sufficient electrical power to support critical equipment. An energy production platform that can be quickly deployed to remote areas and provide sufficient electrical power is crucial in these situations.

Utility electrical grids may suffer outages following natural disasters with repair work often taking weeks to bring the grid back to being fully operational. Providing an electrical power source in these areas or remote austere locations for military purposes may be difficult.

The mobile waterborne energy platform systems and methods described may comprise multiple fuel cells or generators to produce electrical power for critical infrastructure in areas following natural disasters where local utility power may be unavailable or for military purposes in remote austere locations where utility grade power may not be readily available. The waterborne energy platform may be quickly deployed to provide utility grade electrical power source in areas following natural disasters or for military purposes.

### SUMMARY

Embodiments disclosed include a waterborne power generation facility comprising, a marine vessel comprising a hull heat exchange system, a bow section, a stern section, a starboard section, and a port section; an electrical power generating source, wherein the electrical power generating source is comprised in the marine vessel; a reconfigurable thermal containment system comprising a closed loop cooling unit; a reconfigurable thermal airflow system; a hot water return cooling system; and a software management suite comprising a means to collect environmental data, infrastructure data and component data via a plurality of wireless sensors, and to automatically enable dynamic operation actions for migrating power loads to another facility over a grid network.

Embodiments disclosed include, in a power generation facility, a method comprising: generating electrical power and providing the generated electrical power to a dedicated load, wherein any excess power is stored or transmitted through a grid network; pumping surrounding water in close proximity to the power generation facility and circulating the pumped water through a reconfigurable thermal containment system which comprises a closed loop cooling system; wherein the reconfigurable thermal containment system further comprises a single or plurality of heat exchangers; wherein the surrounding water is drawn by water pumps through filtered water intake pipes and pumped through a first side of the heat exchangers to cool hot coolant pumped through a second side of the heat exchangers expelling the pumped water after absorbing the heat from the hot coolant through filtered water exhaust pipes; and via a software management suite, enabling dynamic power generation facility operation actions for migrating power loads to another power generation facility, over a grid network.

Embodiments disclosed include, in a power generating facility, a method of monitoring and managing the facility, the method comprising: collecting of environmental data by a plurality of infrastructure systems, components and wireless sensors; storing the collected data in a database; analyzing the stored data by a predictive analytics engine, wherein the analyzed data is employed by a software management suite element controller to manage infrastructure systems and components' operational states to sustain optimal power generating efficiency.

### BRIEF DESCRIPTION OF THE DRAWINGS

FIG. 1 illustrates a Mobile waterborne data center side view.

FIG. 2 illustrates a Mobile waterborne data center System Flow View.

### DETAILED DESCRIPTION

As stated above, when a natural disaster strikes the impact on communities and businesses can be devastating. Restoring electrical power to areas following a natural disaster is crucial to the recovery process. In many cases electrical power sources may be unavailable for weeks prior to being fully restored.

Military deployments in remote austere locations face challenges providing sufficient electrical power to support critical equipment. An energy production platform that can be quickly deployed to remote areas and provide sufficient electrical power is crucial in these situations. The invention claimed here solves this problem.

The mobile waterborne energy platform systems and methods described may comprise multiple fuel cells or generators to produce electrical power for critical infrastructure in areas following natural disasters where local utility power may be unavailable or for military purposes in remote austere locations where utility grade power may not be readily available. The waterborne energy platform may be quickly deployed to provide utility grade electrical power source in areas following natural disasters or for military purposes.

The claimed invention differs from what currently exists. The claimed invention differs from what currently exists. We are different from, and better than, anything that currently exists. The mobile waterborne energy platform systems and methods described may be employed to quickly provide utility grade electrical power to remote austere locations. The electrical power may be produced by a plurality of fuel cells or generators configured on a mobile waterborne vessel that may be transported to remote areas to provide an on-site electrical power source for critical infrastructure, communications, emergency or medical facilities. The systems and methods are ideal for military purposes where troops may be deployed in remote locations without readily available utility power.

This invention is an improvement on what currently exists. The claimed invention differs from what currently exists. We are different from, and better than, anything that currently exists. The mobile waterborne energy platform systems and methods described may be employed to quickly provide utility grade electrical power to remote austere locations. The electrical power may be produced by a plurality of fuel cells or generators configured on a mobile waterborne vessel that may be transported to remote areas to provide an on site electrical power source for critical infrastructure, communications, emergency or medical facilities. The systems and methods are ideal for military purposes where troops may be deployed in remote locations without readily available utility power.

Utility electrical grids may suffer outages following natural disasters with repair work often taking weeks to bring the grid back to being fully operational. Providing an electrical power source in these areas or remote austere locations for military purposes may be difficult.

The mobile waterborne energy platform systems and methods described may comprise multiple fuel cells or generators to produce electrical power for critical infrastructure in areas following natural

Disasters where local utility power may be unavailable or for military purposes in remote austere locations where utility grade power may not be readily available. The waterborne energy platform may be quickly deployed to provide utility grade electrical power source in areas following natural disasters or for military purposes.

The Version of the Invention Discussed Here Includes:

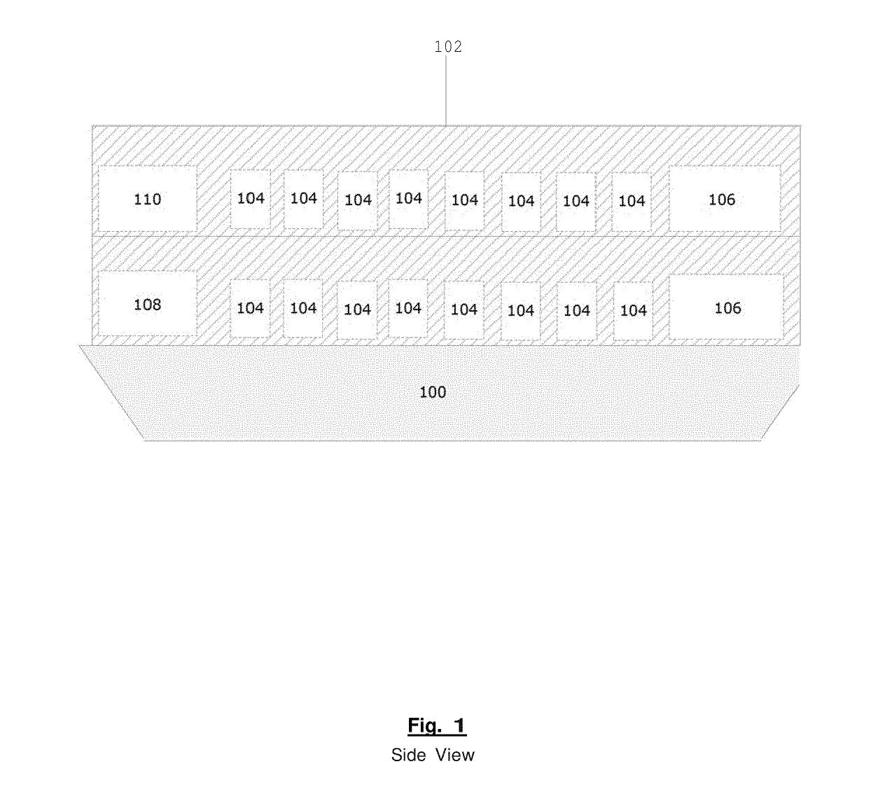

FIG. 1: Side view of waterborne energy platform
a. Item/Step Number #100: purpose built marine vessel
b. Item/Step Number #102: building
c. Item/Step Number #104: fuel cells
d. Item/Step Number #106: fuel tanks
e. Item/Step Number #108: mechanical equipment
f. Item/Step Number #110: electrical equipment

Relationship Between the Components:

One embodiment of the waterborne energy platform is shown in FIG. 1, (side view)

FIG. 1 shows a side view of the waterborne energy platform comprised of a purpose built marine vessel 100, a building 102, a plurality of fuel cells 104, a plurality of fuel tanks 106, a plurality of mechanical equipment 108 and a plurality of electrical equipment 110.

According to an embodiment, the waterborne power generation facility comprises: a marine vessel comprising a hull heat exchange system, a bow section, a stern section, a starboard section, and a port section, an electrical power generating source, wherein the electrical power generating source is comprised in the marine vessel; a reconfigurable thermal containment system comprising a closed loop cooling unit; a reconfigurable thermal airflow system; a hot water return cooling system; and a software management suite comprising a means to collect environmental data, infrastructure data and component data via a plurality of wireless sensors, and to automatically enable dynamic operation actions for migrating power loads to another facility over a grid network.

In an embodiment the closed loop cooling system further comprises a water-based closed loop cooling system, wherein the water based closed-loop cooling system further comprises a single or plurality of filtered water intake pipes and water exhaust pipes, a single or plurality of water pumps, heat exchangers, coolant heat exchange piping, and coolant distribution piping; a closed loop coolant distribution unit, wherein the coolant distribution unit is caused to pass heated coolant through the coolant heat exchange piping, and wherein surrounding water pumped through the filtered water intake pipes is caused to absorb heat from the heated coolant via the single or plurality of heat exchangers.

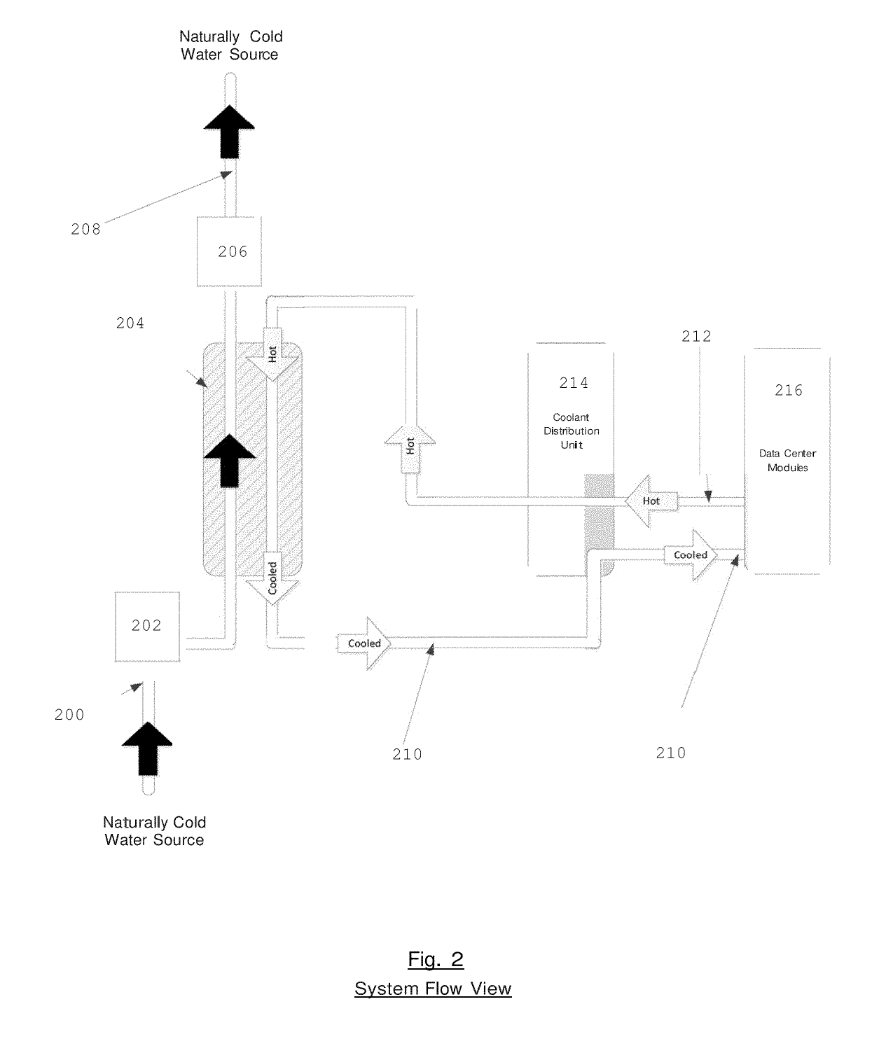

FIG. 2 is a system flow view illustrating the closed loop cooling system. Heat emitted from data center modules 216 is absorbed by a coolant, and the heated coolant is carried away by coolant heat exchange piping 212 via coolant distribution unit 214. Coolant heat exchange piping further passes the heated coolant through heat exchanger 204 wherein natural cold water from the surrounding environment pumped via water pump 202 and passed through the heat exchanger through water inlet 200 is caused to absorb heat and cool the heated coolant before being pumped out through water outlet 208 by water pump 206. The cooled coolant is then caused to circulate around the data center modules via coolant distribution piping 210 through coolant distribution unit 214.

Additionally and alternatively, the power generation facility comprises a plurality of fuel cell modules, wherein each of the plurality of fuel cell modules comprises a fuel cell unit, a plurality of fuel tanks, a plurality of mechanical power generation units, and corresponding water-based cooling units comprised in the thermal containment system.

According to a preferred embodiment, the power generation facility comprises a plurality of water-based cooling units comprised in the thermal containment system, wherein the plurality of water-based cooling units correspond to the amount of heat produced by the power generation facility.

According to an embodiment, the filtered water intake pipes and filtered water exhaust pipes are comprised in the front or back section of the marine vessel. Alternatively, the filtered water intake pipes and filtered water exhaust pipes are comprised in the right or left sides of the vessel. Preferably, the closed loop coolant distribution unit is connected to the heat exchangers and to at least one of the fuel cell modules and the plurality of mechanical power generation units.

According to an embodiment, in the power generation facility, the software management suite further comprises a plurality of analytic engines which are caused to continuously collect and analyze data from a plurality of power distribution components, virtual machines, infrastructure and utility energy markets; the analyzed data causes the analytic engines to trigger automation software that causes the system to make operational state changes for power load balancing across multiple power generation facilities; and wherein data collected from energy markets is used to automatically manage disaster recovery from utility energy market outages, which comprises moving power loads from one power generation facility to another, enabling disaster recovery from utility energy market outages.

The power generation facility further comprises a plurality of wireless sensors comprising means for continuously collecting environmental data.

An embodiment includes, in a waterborne power generation facility, a method comprising generating electrical power and providing the generated electrical power to a dedicated load, wherein any excess power is stored or transmitted through a grid network; pumping surrounding water in close proximity to the power generation facility and circulating the pumped water through a reconfigurable thermal containment system which comprises a closed loop cooling system. The reconfigurable thermal containment system further comprises a single or plurality of heat exchangers, wherein the surrounding water is drawn by water pumps through filtered water intake pipes and pumped through a first side of the heat exchangers to cool hot coolant pumped through a second side of the heat exchangers. Further the pumped water is expelled after absorbing the heat from the hot coolant through filtered water exhaust pipes; and via a software management suite, enabling dynamic power generation facility operation actions for migrating power loads to another power generation facility, over a grid network.

The method further comprises capturing hot exhaust air and returning cooled air to the power generation facility, wherein the hot exhaust air is captured via a reconfigurable thermal airflow system and the thermal airflow system is utilized to move the captured hot exhaust air through the closed loop cooling system, and return the cooled air.

Preferably, the disclosed method includes, via the software management suite, continuously collecting and analyzing data from a plurality of power distribution components, virtual machines, power generation facility infrastructure and utility energy markets, triggering automation software that causes the system to make power generation facility operational state changes for load balancing or power load balancing across multiple power generation facilities; and wherein data collected from energy markets is used to automatically manage power generation facility and disaster recovery from utility energy market outages, which comprises moving power loads from one data center to another, enabling disaster recovery from utility energy market outages.

Embodiments disclosed include, in a power generating facility, a method of monitoring and managing the facility, the method comprising collecting of environmental data by a plurality of infrastructure systems, components and wireless sensors, storing the collected data in a database, analyzing the stored data by a predictive analytics engine, wherein the analyzed data is employed by a software management suite element controller to manage infrastructure systems and components' operational states to sustain optimal power generating efficiency.

The disclosed method further comprises accessing the software management suite over a secure network wherein presentation software comprised in the software management suite enables viewing of all the collected and analyzed data by a user.

Additional, alternative embodiments include intelligent power management and energy market disaster recovery comprising collecting, monitoring and analyzing data from application services, power distribution components, virtual machines, power generating facility infrastructure and utility energy markets. And based on the said collecting, monitoring, and analyzing, dynamically migrating power loads from one facility to another, automatically.

Additionally, according to an embodiment, the method comprises collecting via a data collection layer, data from a plurality of infrastructure elements, application elements, power elements and virtual machine elements, analyzing the collected data via a plurality of analytic engines, and based on the analyzed data, triggering via automation software, power generation facility operational state changes for power load balancing across multiple power generation facilities.

In a preferred embodiment, the method includes, connecting via a network, the power generation facility to a single or plurality of energy markets such that an energy market analysis layer comprised in the software management suite uses data collected from energy market elements to automatically manage data center and application disaster recovery from utility energy market outages.

Preferably the method includes monitoring and analyzing utility energy market status for power generation facility load balancing, wherein the said load balancing comprises moving applications and power loads from one location using power during peak energy hours to another location using power during off peak hours.

How the Invention Works:

The described waterborne energy platform method and system comprise of a purpose-built marine vessel 100 with a pre-fabricated building 102 structure used to house a plurality of fuel cells 104 that may run on fuel supplied by a plurality of fuel tanks 106. A plurality of mechanical equipment 108 may be employed for cooling system components (not pictured). A plurality of electrical equipment 110 may be connected to the plurality of fuel cells 104 and may be used to transmit power produced by the plurality of fuel cells 104 to shore based infrastructure (not pictured) or to another marine vessel (not pictured).

How to Make the Invention:

Design and build a purpose built marine vessel to be employed as a waterborne energy platform. Construct a building on the purpose-built marine vessel to house all equipment. Install all fuel cells, fuel tanks, electrical equipment and mechanical equipment.

All of the elements above are necessary.

In another embodiment, a plurality of generators may be used in place of the plurality of fuel cells.

All of the elements of the waterborne energy platform may be installed in various configurations. Fuel tanks may be installed below deck. The building may be constructed as a two or three story structure. The fuel cells and generators may use diesel or natural gas or liquid natural gas or other such fuels.

Having described at least one embodiment of the present disclosure, various alternations, modifications and improvements will readily occur to those skilled in the art. Such alterations, modifications and improvements are intended to be within the scope and spirit of the disclosure. Accordingly, the foregoing description is by way of example only and is not intended to be limiting.

How to Use the Invention:

The mobile waterborne energy platform may be quickly deployed to areas following natural disasters to provide a utility grade electrical power source for critical infrastructure.

The mobile waterborne energy platform may be quickly deployed to remote military locations to provide a utility grade electrical power source for critical military infrastructure.

The mobile waterborne energy platform may be quickly deployed to provide a utility grade electrical power source for cruise ships or other such marine vessels that have been stranded without power.

The mobile waterborne energy platform may be employed to provide utility grade electrical power for a waterborne data center.

The mobile waterborne energy platform may be employed as a micro grid solution that may be moored and enable systems on shore to go off grid during peak hours.

The mobile waterborne energy platform may be employed as a permanent electrical power source in areas where natural gas is available but electrical power sources are limited.

Additionally: In another embodiment this system and method may be employed as temporary power source for the construction field.

In yet another embodiment the system and method may be moored and employed as a standby emergency power source for critical municipal infrastructure.

Additionally, partial or complete embodiments of the disclosed invention can be utilized in alternate applications without departing from the scope and spirit of the disclosure. For example, mobile waterborne energy platform systems that leverage natural resources within close proximity can be utilized to cool virtually anything, including but not limited to buildings or dwellings, in an energy—efficient and cost—effective manner.

Since various possible embodiments might be made of the above invention, and since various changes might be made in the embodiments above set forth, it is to be understood that all matter herein described or shown in the accompanying drawings is to be interpreted as illustrative and not to be considered in a limiting sense. Thus it will be understood by those skilled in the art of water borne vessels, and computer data centers and that although the preferred and alternate embodiments have been shown and described in accordance with the Patent Statutes, the invention is not limited thereto or thereby.

The figures illustrate the architecture, functionality, and operation of possible implementations of systems, methods and computer program products according to various embodiments of the present invention. It should also be noted that, in some alternative implementations, the functions noted/illustrated may occur out of the order noted in the figures. For example, two blocks shown in succession may, in fact, be executed substantially concurrently, or the blocks may sometimes be executed in the reverse order, depending upon the functionality involved.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Some portions of embodiments disclosed are implemented as a program product for use with an embedded processor. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive, solid state disk drive, etc.); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-accessible format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

The present invention and some of its advantages have been described in detail for some embodiments. It should be understood that although the system and process is described with reference to a mobile waterborne energy platform, the system and process may be used in other contexts as well. It should also be understood that various changes, substitutions and alterations can be made herein without departing from the spirit and scope of the invention as defined by the appended claims. An embodiment of the invention may achieve multiple objectives, but not every embodiment falling within the scope of the attached claims will achieve every objective. Moreover, the scope of the present application is not intended to be limited to the particular embodiments of the process, machine, manufacture, and composition of matter, means, methods and steps described in the specification. A person having ordinary skill in the art will readily appreciate from the disclosure of the present invention that processes, machines, manufacture, compositions of matter, means, methods, or steps, presently existing or later to be developed are equivalent to, and fall within the scope of, what is claimed. Accordingly, the appended claims are intended to include within their scope such processes, machines, manufacture, compositions of matter, means, methods, or steps.

I/We claim:

1. A waterborne power generation facility comprising:
an electrical power generating source, wherein the electrical power generating source is comprised in a marine vessel;
a computer controlled power management system connected to a wired or wireless network, and configured to extract environmental data, infrastructure data and component data from a corresponding plurality of sensors configured to collect the environmental, infrastructure and component data, and connected to the network;
wherein the computer controlled power management system is further configured to enable dynamic operation actions, comprising:
automatically migrating power loads to another facility over a grid network; and
automatically configuring a thermal containment system according to a calculated heat generation based on a load demand.

2. The waterborne power generation facility of claim 1 wherein automatically configuring the thermal containment system further comprises: automatically configuring a closed loop cooling in a closed loop cooling unit comprised in the thermal containment system; automatically configuring a thermal airflow system comprised in the thermal containment system; and automatically configuring a hot water return cooling system comprised in the thermal containment system the closed loop cooling system further comprises a water based closed loop cooling system.

3. The waterborne power generation facility of claim 2 wherein the closed-loop cooling unit comprises:
a single or plurality of filtered water intake pipes and water exhaust pipes;
a single or plurality of water pumps, heat exchangers, coolant heat exchange piping, and coolant distribution piping;
a closed-loop coolant distribution unit; and
wherein the coolant distribution unit is caused to pass heated coolant through the coolant heat exchange piping, and wherein surrounding water pumped through the filtered water intake pipes is caused to absorb heat from the heated coolant via the single or plurality of heat exchangers.

4. The waterborne power generation facility of claim 1 wherein the facility comprises a plurality of fuel cell modules, wherein each of the plurality of fuel cell modules comprises a fuel cell unit; a plurality of fuel tanks; a plurality of mechanical power generation units; and corresponding water-based cooling units comprised in the thermal containment system.

5. The waterborne power generation facility of claim 1 further comprising a plurality of water-based cooling units comprised in the thermal containment system, wherein the plurality of water-based cooling units correspond to the amount of heat produced by the power generation facility.

6. The waterborne power generation facility of claim 3 wherein, the filtered water intake pipes and filtered water exhaust pipes are comprised in the front or back section of the marine vessel respectively.

7. The waterborne power generation facility of claim 3 wherein the filtered water intake pipes and filtered water exhaust pipes are comprised in the right or left sides of the vessel.

8. The waterborne power generation facility of claim 3 wherein the closed-loop coolant distribution unit is connected to the heat exchangers and to at least one of the fuel cell modules and the plurality of mechanical power generation units.

9. The waterborne power generation facility of claim 1 wherein:
the software management suite further comprises a plurality of analytic engines which are caused to continuously collect and analyze data from a plurality of power distribution components, virtual machines, infrastructure and utility energy markets;
the analyzed data causes the analytic engines to trigger automation software that causes the system to make operational state changes for power load balancing across multiple power generation facilities; and
wherein data collected from energy markets is used to automatically manage disaster recovery from utility energy market outages, which comprises moving power loads from one power generation facility to another, enabling disaster recovery from utility energy market outages.

10. The waterborne power generation facility of claim 9 further comprising a plurality of wireless sensors comprising means for continuously collecting environmental data.

11. In a waterborne power generation facility, a method comprising:
generating electrical power and providing the generated electrical power to a dedicated load, wherein any excess power is stored or transmitted through a grid network;
in a computer controlled power management system connected to a wired or wireless network, extracting environmental data, infrastructure data and component data from a corresponding plurality of sensors configured to collect the environmental, infrastructure and component data, and connected to the network;
enabling dynamic operation actions via the computer controlled power management system, wherein the enabling comprises:
automatically migrating power loads to another facility over a grid network; and
automatically configuring a thermal containment system according to a calculated heat generation based on a load demand.

12. The method of claim 11, wherein automatically configuring the thermal containment system further comprises:
automatically configuring a closed loop cooling in a closed loop cooling unit comprised in the thermal containment system;
automatically configuring a thermal airflow system comprised in the thermal containment system; and
automatically configuring a hot water return cooling system comprised in the thermal containment system;
wherein automatically configuring the thermal airflow system comprises capturing hot exhaust air and returning cooled air to the power generation facility; and
wherein the hot exhaust air is captured via a reconfigurable the thermal airflow system and the thermal airflow system is utilized to move the captured hot exhaust air through the closed loop cooling system, and return the cooled air.

13. The method of claim 11, further comprising:
via the software management suite, continuously collecting and analyzing data from a plurality of power distribution components, virtual machines, power generation facility infrastructure and utility energy markets;
triggering automation software that causes the system to make power generation facility operational state changes for load balancing or power load balancing across multiple power generation facilities; and
wherein data collected from energy markets is used to automatically manage power generation facility and disaster recovery from utility energy market outages, which comprises moving power loads from one data center to another, enabling disaster recovery from utility energy market outages.

14. In a power generating facility, a method of monitoring and managing the facility, the method comprising:
collecting of environmental data by a plurality of infrastructure systems, components and wireless sensors;
storing the collected data in a database; and
analyzing the stored data by a predictive analytics engine, wherein the analyzed data is employed by a software management suite element controller to manage infrastructure systems and components' operational states to sustain optimal power generating efficiency.

15. The method of claim 14 further comprising:
accessing the software management suite over a secure network wherein presentation software comprised in the software management suite enables viewing of all the collected and analyzed data by a user.

16. The method of claim 14 further comprising:
intelligent power management and energy market disaster recovery comprising:
collecting, monitoring and analyzing data from application services, power distribution components, virtual machines, power generating facility infrastructure and utility energy markets; and
based on the said collecting, monitoring, and analyzing, dynamically migrating power loads from one facility to another, automatically.

17. The method claim 16 further comprising:
collecting via a data collection layer, data from a plurality of infrastructure elements, application elements, power elements and virtual machine elements;
analyzing the collected data via a plurality of analytic engines; and
based on the analyzed data, triggering via automation software, power generation facility operational state changes for power load balancing across multiple power generation facilities.

18. The method of claim 16 further comprising:
connecting via a network, the power generation facility to a single or plurality of energy markets such that an energy market analysis layer comprised in the software management suite uses data collected from energy market elements to automatically manage data center and application disaster recovery from utility energy market outages.

19. The method of claim 16 wherein intelligent power management and energy market disaster recovery comprises:
monitoring and analyzing utility energy market status for power generation facility load balancing, wherein the said load balancing comprises moving applications and power loads from one location using power during peak energy hours to another location using power during off-peak hours.
